(19) United States
(12) Patent Application Publication
(10) Pub. No.: US 2015/0067772 A1
(43) Pub. Date: Mar. 5, 2015

(54) APPARATUS, METHOD AND COMPUTER-READABLE STORAGE MEDIUM FOR PROVIDING NOTIFICATION OF LOGIN FROM NEW DEVICE

(71) Applicant: NAVER CORPORATION, Gyeonggi-do (KR)

(72) Inventors: Jong Won Paek, Seongnam-si (KR); Tae Ki Ha, Seongnam-si (KR); June Mok Lee, Seongnam-si (KR)

(21) Appl. No.: 14/314,300

(22) Filed: Jun. 25, 2014

(30) Foreign Application Priority Data
Sep. 3, 2013 (KR) 10-2013-0105649

(51) Int. Cl. H04L 29/06

(52) U.S. Cl. CPC H04L 63/00
USPC 726/2

(57) ABSTRACT

An apparatus for providing a notification of a login to a user account from a device includes an information analysis unit for determining whether the device is a new device, in response to a login request received from the device, and a login notification unit for providing a notification of a login from the new device using a preset notification method, based on results of determination by the information analysis unit. A login notification is provided when a user logs in via a new device other than devices usually used thereby, thus allowing the user to promptly cope with an illegal login so that the illegal use of the user's account can be prevented if an illegal login is performed.

### BACKGROUND OF THE INVENTION

1. Field of the Invention

The present invention relates, in general, to an apparatus for providing a notification of a login from a new device and, more particularly, to an apparatus, a method and a computer-readable storage medium for providing a notification of a login from a new device, which are configured to, when a login to a user account is performed at a device which has not previously been registered by a user or via which the user has not yet logged in (for example, a browser, a mobile application, or a terminal), notify the user of the login using preset methods, thus allowing the user to voluntarily and promptly conduct security activity.

2. Description of the Related Art

Recently, as various security threats have increased, security accidents caused by the leakage and illegal use of a login ID and a password frequently occur, thus leading to various cyber crimes and a property loss attributable to the online leakage of personal information.

Generally, the leakage and illegal use of a login ID and a password are conducted by hacking or the infection of viruses or malicious codes. In order to prevent damage caused by malicious codes or hacking, online firewall solutions such as anti-virus, anti-spyware or adware are provided. However, since such an online firewall solution requires continuous updating of patterns and also requires management of security by the user, it cannot realistically be a fundamental alternative plan for preventing leakage of personal information.

Further, most user authentication methods which are still performed over the Internet follow a single user authentication method executed using only a login ID and a password. However, this user authentication method, dependent on previously known information, has a higher risk of personal information being leaked.

Therefore, in order to overcome such a disadvantage, a two-factor authentication method in which schemes based on biometrics, a One-Time Password (OTP), a public key infrastructure (PKI), etc., in addition to a login ID and a password, are combined with each other has been proposed.

Among these schemes, the biometrics scheme not only has a high incidence of recognition errors, but also has limitations in mobility, and thus the OTP scheme has recently been widely used.

The OTP scheme denotes a method of creating and inputting different random passwords at each time rather than a method of creating a fixed password, and is a useful authentication solution capable of reducing the possibility of a leaked password and the illegal use a user's account because it is impossible to reuse a password. In this way, as security login technology using a one-time password scheme, Korean Patent No. 10-1033547 entitled “OTP authentication apparatus and PC security logon method using the apparatus” filed by Feelanet Co., Ltd. and Rekcahz Co., Ltd. (Patent document 1) discloses a PC security logon method using an OTP authentication device, which adds a third security means such as an OTP device by overcoming an existing logon method of simply inputting a user ID or a user password, thus constructing a strong security level.

However, the one-time password scheme is problematic in that, in order to use a one-time password (OTP), a user must carry a separate OTP generator and pay an additional fee when an OTP generator is reissued due to loss or other causes. Further, the OTP scheme is inconvenient in that generated OTPs must be individually input to a terminal connected to a network for user authentication, and is problematic in that authentication error frequently occurs due to a time delay or input error and a procedure for identification between an OTP owner and an owner who holds a user account is insufficient.

In order to solve this problem, technology has been proposed in which a text message including a temporary password for secure access is transmitted to the contact of a user corresponding to a login ID in a login procedure, and the temporary password is re-input from the user as a security access number, and in which a member authentication procedure is performed only when the security access number is identical to the previously transmitted temporary password.

However, such conventional technology is problematic in that, even when a correct user logs in via a device usually used thereby, the user is unconditionally forcibly requested to be additionally authenticated via a mobile terminal and email, thus deteriorating the user's convenience.

Therefore, there is required a method which provides a login notification so that a user may immediately check a login in a case where the user logs in via a new device other than devices usually used thereby, and which can provide the user's convenience while allowing the user to promptly cope with an illegal login if an illegal login is performed.

### SUMMARY OF THE INVENTION

Accordingly, the present invention has been made keeping in mind the above problems occurring in the prior art, and an object of the present invention is to provide an apparatus, a method, and a computer-readable storage medium for providing a notification of a login from a new device, which provide a login notification when a user logs in to a user's account via a new device other than devices usually used thereby, thus allowing the user to promptly cope with an illegal login so that the illegal use of the user's account can be prevented if an illegal login is performed.

Another object of the present invention is to provide an apparatus, a method, and a computer-readable storage medium for providing a notification of a login from a new device, which provide a login notification using various methods preset by a user when the user logs in via a new device other than devices usually used thereby, thus allowing the user to immediately realize an illegal login.

A further object of the present invention is to provide an apparatus, method, and computer-readable storage medium for providing a notification of a login from a new device, which provide a login notification when a user logs in via a new device other than devices usually used thereby, thus enhancing the user's convenience.

The characteristic configuration of the present invention to accomplish the above objects and achieve the unique features of the present invention is described as follows.

In accordance with an aspect of the present invention, there is provided an apparatus for providing a notification of a login from a new device, including an information analysis unit for determining whether a device is a new device, in response to a login request received from the device, and a login notification unit for providing a notification of a login from the new device using a preset notification method, based on results of determination by the information analysis unit.

Preferably, the information analysis unit may determine whether a device is a new device, based on one or more of first analysis of analyzing whether additional information as well as basic information is included in the login request, and second analysis of analyzing whether a login record based on the basic information and the additional information is present.

Preferably, the additional information may include one or more of cookie information, an application program identifier (ID), and an Internet Protocol (IP) address and a User-Agent field included in a Hypertext Transfer Protocol (HTTP) request.

Preferably, the preset notification method may include one or more of a notification based on a Social Network Service (SNS) account, a notification based on email, a notification based on an application program installed in a terminal, a notification based on a messenger program installed in the terminal, and a notification based on a Short Message Service (SMS).

Preferably, the apparatus may further include a new device registration unit for registering the device requesting a login as a new device, based on the results of determination by the information analysis unit.

Preferably, the new device registration unit may generate additional information required to identify the device, and register the device as the new device by mapping the additional information to the login request.

Preferably, the apparatus may further include a notification method storage unit for registering a notification method set by selection of a user.

Preferably, the apparatus may further include a login processing unit for processing the login in response to the received login request, and creating or updating the login record.

Preferably, the new device may be a user terminal or a predetermined application program installed in the user terminal.

In accordance with another aspect of the present invention, there is provided a method of providing a notification of a login from a new device, the method being performed by a new device login notification apparatus, including performing information analysis by determining whether a device is a new device, in response to a login request received from the device, and performing login notification by providing a notification of a login from the new device using a preset notification method, based on results of determination at performing the information analysis.

Information required to perform the method of providing a notification of a login from a new device may be stored in a server computer-readable storage medium. Such a storage medium includes all types of storage media for storing programs and data so that they are readable by a computer system. Examples of the computer-readable storage medium include Read Only Memory (ROM), Random Access Memory (RAM), Compact Disc (CD), Digital Versatile Disc (DVD)-ROM, magnetic tape, a floppy disc, an optical data storage device, etc., and also include the implementation of a form of a carrier wave (for example, via transmission over the Internet). Further, the computer-readable storage medium may be distributed across computer systems connected to each other over a network and may be stored and executed as computer-readable code in a distributed manner.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of an overall system including an apparatus for providing a notification of a login from a new device according to the present invention;

FIG. 2 is a block diagram showing the detailed configuration of the new device login notification apparatus according to an embodiment of the present invention; and

FIG. 3 is a flowchart showing a notification procedure when a login from a new device is requested according to an embodiment of the present invention.

### DESCRIPTION OF THE PREFERRED EMBODIMENTS

A detailed description of the present invention will be made with reference to the attached drawings in which specific embodiments for implementing the present invention are illustrated. These embodiments will be described in detail such that the present invention can be sufficiently practiced. It should be understood that various embodiments of the present invention are different, but they do not need to be exclusive. For example, specific shapes, structures, and characteristics described in the present specification may be implemented in different embodiments without departing from the spirit and scope of the present invention in relation to embodiments. Further, it should be understood that the locations or arrangement of individual components in the disclosed embodiments may be changed without departing from the spirit and scope of the present invention. Therefore, the following detailed descriptions are not intended to restrict the present invention, and the scope of the present invention is defined only by the accompanying claims and equivalents thereof as long as it is suitably described. The same reference numerals are used throughout the different drawings to designate the same or similar components.

The present invention discloses an apparatus for providing a notification of a login from a new device, which is configured to, when a login is performed via a device, determine whether the login device is a device which has not previously been registered by the user, or via which the user has never logged in, and is configured to, if it is determined that the login device is a device satisfying the condition, notify the user of the login using various preset methods, so that the user can promptly take a required action, such as a logout, password change, or login management, thus preventing the user's account from being illegally used.

the term “device” in the following description includes a user terminal, which will be described later, and may further include an application program installed in the user terminal. Therefore, the term “new device” in the present invention may be a user terminal which has not previously been registered or via which the user has never logged in using his or her ID and password. Alternatively, even if the terminal is a user terminal via which the user has logged in through another application program, when the user has never logged in through a specific application program via which a login is currently being attempted, the “new device” may be the specific application program.

Further, in the following description, the term “user terminal” is a concept including a smart phone as well as a desktop computer. Any type of digital device may be adopted as the user terminal according to the present invention as long as the digital device is provided with a memory and is equipped with a microprocessor to have a computation ability, such as a mobile communication terminal, a desktop computer, a notebook computer, a workstation, a palmtop computer, a Personal Digital Assistant (PDA), and a webpad.

Hereinafter, preferred embodiments of the present invention will be described in detail with reference to the attached drawings so that those having ordinary knowledge in the technical field to which the present invention pertains can easily practice the present invention.

Overall System Including Apparatus for Providing Notification of Login from New Device

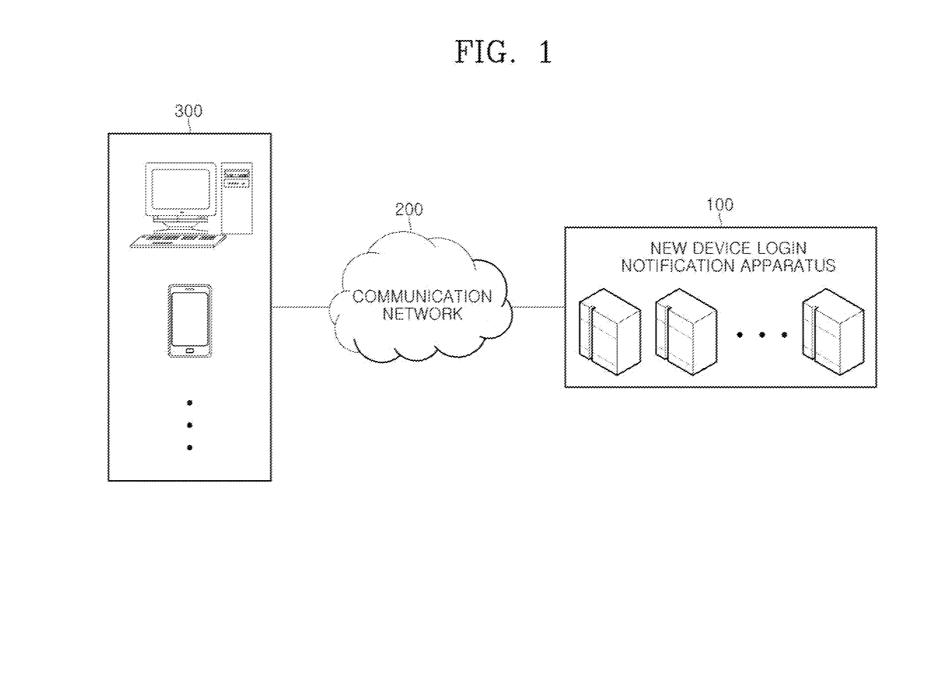

FIG. 1 is a diagram showing the configuration of the overall system including an apparatus for providing a notification of a login from a new device according to the present invention.

Referring to FIG. 1, the overall system according to the embodiment of the present invention is configured such that an apparatus 100 for providing a notification of a login from a new device is connected to a user terminal 300 over a communication network 200.

The new device login notification apparatus 100 basically provides various types of services (for example, email, a blog, a homepage, etc.) via a login, and determines whether the user terminal 300 or an application program which requests a login is a new device, based on additional information transmitted together with a login request from the user terminal 300. If it is determined that the user terminal 300 or the application program is a new device, the new device login notification apparatus 100 notifies the user that a login has been performed via the new device, using various preset notification methods, and provides various handling functions depending on the selection of the user (for example, a logout, password change, login management, or the like).

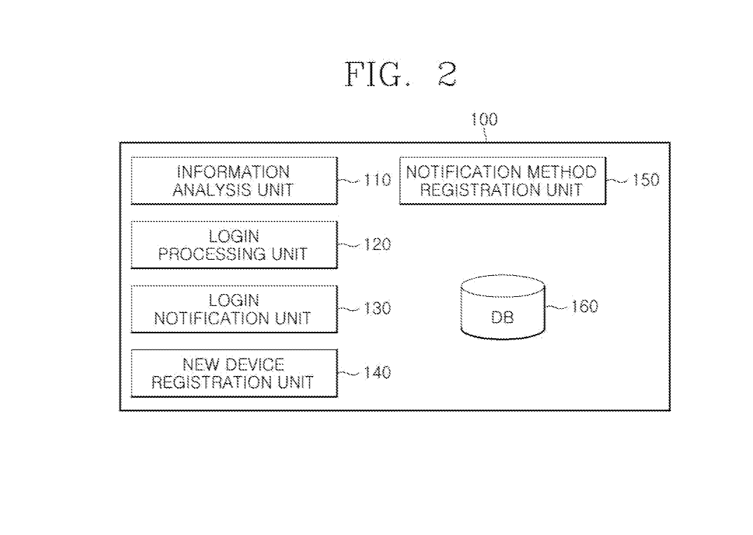

If it is determined that the device requesting a login is a new device, the new device login notification apparatus 100 may further provides the function of registering the device as a new device. The new device login notification apparatus 100 may further include the function of allowing the user to select a notification method for the login from the new device. Individual components of the new device login notification apparatus 100 and detailed operations thereof will be described in detail later with reference to FIG. 2.

The communication network 200 may be configured regardless of a communication type such as wired or wireless communication, and may be configured using any of various communication networks, such as a Personal Area Network (PAN), a Local Area Network (LAN), a Metropolitan Area Network (MAN), and a Wide Area Network (WAN). Further, the communication network 200 may be a well-known World Wide Web (WWW) and may be implemented using wireless transmission technology used for short-range communication, such as Infrared Data Association (IrDA) or Bluetooth.

The user terminal 300 may transmit basic information, such as a user ID and a password, and additional information so as to be provided with services from the new device login notification apparatus 100, and may be provided with various types of services based on the results of login processing received from the new device login notification apparatus 100. Further, if it is determined that the device requesting the login is a new device, the user terminal 300 may receive a screen required to register the device as a new device from the new device login notification apparatus 100 and register the new device by entering the name or the like of the new device, and may additionally select notification methods for the login from the new device. Meanwhile, the user may recognize that a login has been performed via the new device based on at least one of various notification methods for the login from the new device.

### New Device Login Notification Apparatus

FIG. 2 is a block diagram showing a detailed configuration of the new device login notification apparatus according to an embodiment of the present invention.

Referring to FIG. 2, the new device login notification apparatus 100 according to the embodiment of the present invention includes an information analysis unit 110, a login processing unit 120, a login notification unit 130, a new device registration unit 140, a notification method registration unit 150, and a database (DB) 160.

The information analysis unit 110 functions to receive basic information and additional information from a device requesting a login, and determine whether the device requesting the login corresponds to a new device, based on the received information.

“Basic information” in the embodiment of the present invention is defined as information including all information required for a login. The basic information generally includes a user ID and a password, and may further include other pieces of information required for a login (for example, a One Time Password (OTP), an authentication number, etc.).

“Additional information” in the embodiment of the present invention is defined as information additionally required so as to determine whether the device requesting a login is a new device, in addition to the basic information. The additional information may include, but is not limited to, cookie information, an application ID, an Internet Protocol (IP) address and a User-Agent field which are included in a Hypertext Transfer Protocol (HTTP) request, etc.

Cookie information is a kind of information file, which may be automatically created when the user terminal 300 accesses the new device login notification apparatus 100 using a browser and may be provided to the user terminal 300, and may further include a unique value enabling the user terminal 300 to be distinguished from other user terminals. The application ID denotes a unique value enabling a specific application, which is executed on the user terminal 300 and requests a login, to be distinguished from other application programs. Further, the ‘HTTP request’ denotes a format used to request information from a server which provides a web service. In this case, the header thereof may include values of a User-Agent field, and the server may identify a base Operating System (OS), on which an entity requesting the information is running, and which type of application program is executed, based on the values included in the User-Agent field.

In greater detail, when the additional information is, for example, cookie information, the information analysis unit 110 determines whether cookie information has been received, in response to the login request of the user terminal 300. If it is determined that cookie information is not received, it may be determined that cookie information has been neither generated in the domain of the new device login notification apparatus 100 nor transmitted to the user terminal 300, and thus it may be determined that the user terminal 300 is a new device. Further, when a unique value required to identify the user terminal 300 is not included in cookie information even if the cookie information is received, or when a login record, in which basic information and additional information are mapped to each other and are stored, is not present in the DB 160 even if the unique value is included, it may be determined that the user terminal 300 is a new device.

For example, when additional information is an application ID, the information analysis unit 110 determines whether an application ID has been received in response to a login request received from a specific application program installed in the user terminal 300. If an application ID has not been received, it may be determined that the new device login notification apparatus 100 has neither generated an application ID for the accessed application program nor provided the application ID to the user terminal 300, and thus it may be determined that the corresponding application program is a new device. Further, even if the application ID has been received, when a login record in which basic information and additional information are mapped to each other and are stored is not present in the DB 160, it may be determined that the application program is a new device.

Similarly, when the additional information is an IP address and a User-Agent field, the information analysis unit 110 may specify a device requesting a login, based on the information, check a login record, and determine whether the device is a new device.

If it is determined that the device requesting a login is a new device, the information analysis unit 110 may request the login notification unit 130, which will be described later, to notify the user of the login, and may additionally request the new device registration unit 140 to register the device as a new device, in addition to login processing performed by the login processing unit 120. If the device is not a new device, a login is processed via the login processing unit 120 without the functions of the login notification unit 130 and the new device registration unit 140, thus providing services requested by the device requesting the login.

The login processing unit 120 functions to process the login of the device requesting the login, thus providing the requested service to the corresponding device.

The login processing unit 120 may create or update a login record in the DB 160 upon performing a login, and store basic information and additional information received from the device so that they are mapped to each other. Further, a login session may be stored in the DB 160, and a session key may be transmitted to the user terminal 300, thus allowing the device requesting the login to be maintained in a login state. In this case, additional information such as cookie information or an application ID, together with the session key, may be further provided to the device, so that when a login request is received later from the same device, the additional information provided to the device may be received.

As a result of the analysis by the information analysis unit 110, if it is determined that the new device has requested a login, the login notification unit 130 functions to notify the user of the login, based on notification methods previously set by the notification method registration unit 150 and stored in the DB 160.

The notification methods may include various notification methods, for example, a notification based on the Social Network Service (SNS) account of the user, a notification based on the user's email, a notification based on a mobile application program installed in the user's mobile terminal or the messenger program of the user, and a notification based on a Short Message Service (SMS) message to the mobile terminal of the user, so that the user can immediately check the login.

Below, embodiments of a method of notifying the user whether a login has been performed via a new device using various types of notification methods according to various embodiments of the present invention will be described.

A first embodiment of a login notification method according to the present invention may be implemented using a notification based on the Social Network Service (SNS) account of the user. For example, if it is determined that when a login is requested by a new device, the login notification unit 130 accesses the SNS of the user stored in the DB 160, and writes a new message, indicating that a login has been performed via the new device, on the user's account, thus notifying the user of the login from the new device.

A second embodiment of the login notification method according to the present invention may be implemented using a notification based on the email of the user. The login notification unit 130 may send an email, indicating that a login has been performed via the new device, to the email account of the user stored in the DB 160. In this case, detailed information, such as a user ID used for a login, login date and time, an Operating System (OS), a browser, and a login IP address, may be further written in the email to be sent, thus allowing the user to conveniently check whether the current login corresponds to the user's login. The email to be sent may further include handling information corresponding to a link enabling login management, password change, or a logout to be immediately executed such that, if the current login is not the user's login, the user may immediately cope with the current login. In this case, the detailed information may be acquired from the reception date and time of an HTTP request, and an IP address and a User-Agent field included in the HTTP request.

A third embodiment of the login notification method according to the present invention may be implemented using a notification based on a mobile application program. If a method of sending a push alarm to a previously installed mobile application program is used, a push alarm indicating that a login has been performed via the new device is displayed on the screen of the mobile terminal of the user, thus allowing the user to immediately check the login. In this case, the user may check more detailed contents by selecting the alarm.

A fourth embodiment of the login notification method according to the present invention may be implemented using a notification based on the messenger program of the user. Similar to the above-described mobile application program, the login notification unit 130 may send a message including detailed information and handling information to the messenger account of the user stored in the DB 160, and, as a result, the user may check the message from his or her messenger program and may suitably cope with the current login.

A fifth embodiment of the login notification method according to the present invention may be implemented using a notification based on a short message (SMS message) to the mobile terminal of the user. The login notification unit 130 may send a message, including detailed information and handling information, to the phone number of the user's terminal stored in the DB 160. As a result, the user may check the message from his or her terminal.

In this way, in accordance with the embodiments of the present invention, various notification methods may be used, but the notification of the present invention is not limited thereto. When a current login is not the user's login, the present invention may provide functions such as a logout function, a password change function, or a login management function in a notification so that the user may receive the notification and voluntarily start security activity, but the function of the present invention is not limited thereto.

Referring back to FIG. 2, the new device registration unit 140 is configured to, if it is determined as a result of the analysis by the information analysis unit 110 that a new device requests a login, perform the function of registering the new device, thus enabling a login to be processed and a service to be provided when a login from the same device is requested later.

As an embodiment of device registration, when a login from a new device is requested, the new device registration unit 140 may provide an interface capable of registering the new device and may allow new devices to be registered depending on selection. When the name of a new device is input, the new device registration unit 140 may generate a unique value enabling the corresponding device to be identified, transmit the unique value as an application ID or as additional information including cookie information to the device requesting the login, and store two or more of basic information, additional information, and the device name as device registration information in the DB 160 so that the pieces of information are mapped to each other. If the user's selection concerning the non-registration of the device is received, additional information is not generated, so that, even if a login from the same device is requested, the device may still be recognized as a new device. If the information analysis unit 110 receives the additional information, but only a login record is not present, device registration information may be registered using previously received additional information without separate additional information being generated.

As another embodiment of device registration, the new device registration unit 140 may automatically generate an application ID or cookie information including a unique value without providing an interface capable of registering new devices, transmit the generated application ID or cookie information to the device requesting the login, and store the generated information as device registration information in the DB 160 so that the generated information is mapped.

The notification method registration unit 150 provides the function of allowing the user to select a notification method for a login from a new device. As described above, the notification methods may include various notification methods, for example, a notification based on the SNS account of the user, a notification based on the user's email, a notification based on the mobile application program or the messenger program of the user, which is widely used in the user's mobile terminal, a notification based on an SMS message to the mobile terminal of the user, etc. Further, the notification method registration unit 150 provides a login management interface in response to the user's request after the login. When the user selects one or more of his or her desired notification methods, the notification method registration unit 150 stores the selected notification methods in the DB 160, and allows the login notification unit 130 to use the notification methods.

As an example of a method of setting a notification method for a login from a new device according to the embodiment of the present invention, the function of allowing the user to select login notification items for various notification methods on the login management interface after the user has logged in may be provided. When the user selects one from among the login notification items and then clicks a confirm key, a selected notification method is stored in the DB 160. Further, the function of additionally providing registered device information to the user or the function of deleting a notification item depending on the user's selection may be provided.

The DB 160 denotes a space in which various pieces of data generated from the respective components of the new device login notification apparatus 100 during the performance of the present invention may be temporarily or permanently stored. In more detail, the DB 160 stores login records, login sessions, notification methods, device registration information, etc., but the type of stored information is not limited thereto.

The individual components of the new device login notification apparatus 100 are separately illustrated in the drawing so as to indicate that they may be functionally and logically separated. However, such illustration does not necessarily mean that those components are essentially implemented as separate components or implemented as separate codes.

Further, individual functional units (or modules) in the present specification may denote a functional or structural combination of hardware for performing the technical spirit of the present invention and software for executing the hardware. For example, individual functional units may denote logical units of predetermined codes and logical units of hardware resources for executing the predetermined codes, but a person having ordinary knowledge in the art to which the present invention pertains will easily understand that the functional units do not necessarily denote physically connected codes or one type of hardware.

### New Device Login Notification Procedure

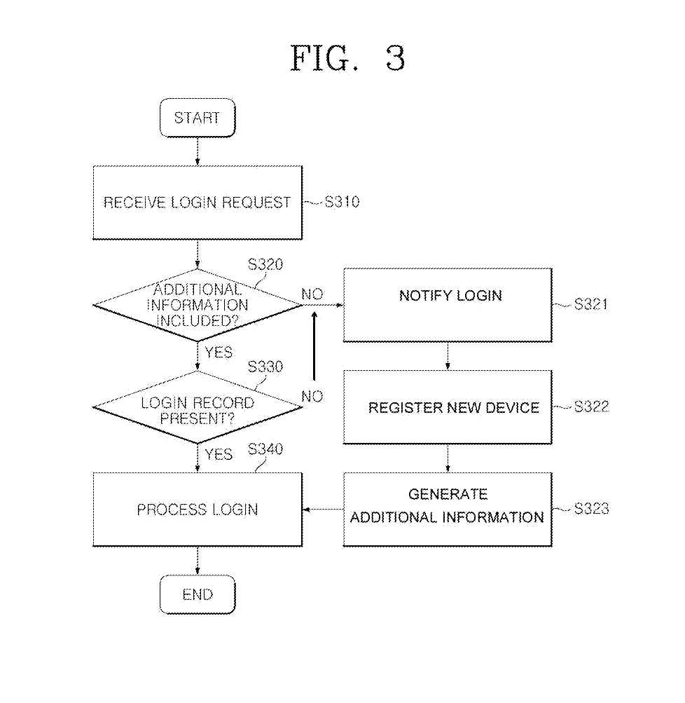

FIG. 3 is a flowchart showing a notification procedure performed when a login from a new device is requested according to an embodiment of the present invention.

Referring to FIG. 3, when a login request to a user's account is received from a predetermined device at step S310, the information analysis unit 110 determines whether additional information is included in the received login request at step S320. As described above, the additional information may include, but is not limited to, an application ID, cookie information, or the IP address and the User-Agent field of an HTTP request.

If it is determined at step S320 that additional information is not included, it is determined that the device requesting a login is a new device, and the login notification unit 130 notifies the user of the login from the new device at step S321. The notification of the login from the new device may be provided with reference to the notification methods stored in the DB 160.

In this case, the step S322 of allowing the new device registration unit 140 to register the new device may be further performed, wherein the method must further include the step S323 of generating additional information including a unique value enabling the corresponding device to be identified.

Meanwhile, if it is determined at step S320 that the additional information is included, the information analysis unit 110 determines whether a login record via the corresponding device is present, based on basic information and the additional information included in the login request at step S330.

If it is determined at step S330 that a login record is not present, it is determined that the device requesting the login is a new device, and the login notification step S321 and the new device registration step S322 are separately performed.

Those skilled in the art will appreciate that some of steps 321, S322, and S323 in FIG. 3 may be omitted in accordance with embodiments, and the processing sequence of individual steps may also be designed to be freely changed without being limited to the specific sequence of the example illustrated in FIG. 3.

If, at step S330, a login record is present, it is determined that the device is not a new device, and the login processing unit 120 performs normal login processing at step S340. Even in the new device, the login processing step S340 may be further performed at any time regardless of before and after login notification step S321 and, additionally, new device registration step S323 are performed.

At step S340, in greater detail, a login record may be created or updated depending on login processing, a login session is generated and stored, and a session key is transmitted to the device requesting the login to allow the device to be maintained in a login state. In this case, the additional information may be further provided together with the session key to the corresponding device, so that when a login request is received from the same device, the provided additional information may be received.

The method according to the embodiment of the present invention may be implemented in the form of program instructions that can be executed by various computer means and may be recorded on a computer-readable storage medium. The computer-readable storage medium may include program instructions, data files, and data structures solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine code, such as code created by a compiler, and high-level language code executable by a computer using an interpreter. The hardware devices may be configured to operate as one or more software modules in order to perform the operation of the present invention, and the vice versa.

As described above, although the present invention has been described with reference to specific details such as detailed components, limited embodiments, and drawings, those are merely provided to help the overall understanding of the present invention and are not intended to limit the present invention to the embodiments, and those skilled in the art will change and modify the present invention in various manners from the above description.

Therefore, the spirit of the present invention should not be limited by the above-described embodiments and it should be understood that the accompanying claims and equipments thereof fall within the spirit and scope of the present invention.

What is claimed is:

1. An apparatus for providing a notification of a login to a user account from a device, comprising:
a processor;
a storage device in communication with the processor for storing a plurality functional units that are executed by the processor for providing the login notification, the functional units including,
an information analysis unit for determining whether the device is a new device, in response to a login request received from the device; and
a login notification unit for providing a notification of a login from the new device using a preset notification method, based on results of determination by the information analysis unit.

2. The apparatus of claim 1, wherein the information analysis unit determines whether the device is the new device, based on at least one of first analysis of analyzing whether additional information as well as basic information is included in the login request and second analysis of analyzing whether a login record based on the basic information and the additional information is present.

3. The apparatus of claim 2, wherein the additional information includes at least one of cookie information, an application program identifier (ID), and an Internet Protocol (IP) address and a User-Agent field included in a Hypertext Transfer Protocol (HTTP) request.

4. The apparatus of claim 1, wherein the preset notification method includes at least one of a notification based on a Social Network Service (SNS) account, a notification based on email, a notification based on an application program installed in a terminal, a notification based on a messenger program installed in the terminal, and a notification based on a Short Message Service (SMS).

5. The apparatus of claim 1, further comprising a new device registration unit for registering the device requesting the login as the new device, based on the results of determination by the information analysis unit.

6. The apparatus of claim 5, wherein the new device registration unit generates additional information required to identify the device, and registers the device as the new device by mapping the additional information to the login request.

7. The apparatus of claim 1, further comprising a notification method storage unit for registering a notification method set by a selection of a user.

8. The apparatus of claim 1, further comprising a login processing unit for processing the login in response to the received login request, and creating or updating a login record.

9. The apparatus of claim 1, wherein the new device is a user terminal or a predetermined application program installed in the user terminal.

10. A method of providing a notification of a login to a user account from a device, comprising:
Performing, by a processor, information analysis by determining whether the device is a new device, in response to a login request received from the device; and
transmitting, by the processor, login notification by providing a notification of a login from the new device using a preset notification method, based on results of the determination from performing the information analysis.

11. The method of claim 10, wherein performing the information analysis comprises:
performing first analysis of analyzing whether additional information as well as basic information is included in the login request;
performing second analysis of analyzing whether a login record based on the basic information and the additional information is present; and
determining whether the device is the new device, based on at least one of the first analysis and the second analysis.

12. The method of claim 11, wherein the additional information includes at least one of cookie information, an application program identifier (ID), and an Internet Protocol (IP) address and a User-Agent field included in a Hypertext Transfer Protocol (HTTP) request.

13. The method of claim 10, wherein the preset notification method includes at least one of a notification based on a Social Network Service (SNS) account, a notification based on email, a notification based on an application program installed in a terminal, a notification based on a messenger program installed in the terminal, and a notification based on a Short Message Service (SMS).

14. The method of claim 10, further comprising registering the device requesting the login as the new device, based on the results of the determination from performing the information analysis. 20

15. The method of claim 14, wherein registering as the new device comprises:
generating additional information required to identify the device; and
registering the device as the new device by mapping the additional information to the login request.

16. The method of claim 10, further comprising registering a notification method set by a selection of a user.

17. The method of claim 10, further comprising processing the login in response to the received login request, and creating or updating a login record.

18. The method of claim 10, wherein the new device is a user terminal or a predetermined application program installed in the user terminal.

19. A non-transitory computer-readable storage medium storing a program for providing a notification of a login to a user account from a new device, the program when executed by a processor performs the functions comprising:
performing information analysis by determining whether the device is a new device, in response to a login request received from the device; and
transmitting login notification by providing a notification of a login from the new device using a preset notification method, based on results of the determination from performing the information analysis.
